(19) United States
(12) Patent Application Publication
(10) Pub. No.: US 2006/0122844 A1
(43) Pub. Date: Jun. 8, 2006

(54) Accelerated transmission of hypertext documents

(75) Inventor: Andreas Dangberg, Paderborn (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/512,974

(22) PCT Filed: Apr. 29, 2003
(86) PCT No.: PCT/DE03/01379

§ 371 Date: Jul. 13, 2005

(30) Foreign Application Priority Data
Apr. 30, 2002 (DE) 102 19 390.8

(51) Int. Cl. G06Q 99/00

(52) U.S. Cl. 705/1

(57) ABSTRACT

When a HTML page is requested, an indicator is set by a browser and is used to enable the server to send back an archive, in the place of the HTML page, which is unpacked by the browser in the cache. The archive contains, for example, the images which are required by said page and which are retrieved from the cache such that only one network transfer is required per page. The invention is compatible with previous operations, especially by using content negotiation according to RFC 2295 or remote variant selection according to RFC 2296.

### CLAIM FOR PRIORITY

This application is a national stage of PCT/DE03/01379, published in the German language on Nov. 13, 2003, which claims the benefit of priority to German Application No. DE 102 19 390.8, filed on Apr. 30, 2002.

### TECHNICAL FIELD OF THE INVENTION

The invention relates to the accelerated transfer of Hypertext documents, and in particular, to HTML pages, with the HTTP protocol.

### BACKGROUND OF THE INVENTION

The use of the network known as the Internet with display programs called browsers, the markup language HTML and the HTTP protocol are generally known in detail to the relevant person skilled in the art.

For the retrieval of HTML pages, the authors of the pages are making ever greater use of graphics and other embedded components. The effect of this is that the HTML page initially addressed by a URL is retrieved from the server specified therein and transferred to the browser. After a page (or the first part of it) is received, it is analyzed in accordance with the syntax levels of HTML, with the elements being marked by tags. During this operation graphics are embedded by the IMG tag. The ‘SRC=’ parameter of the IMG tag contains the address of a graphics or image file to be loaded. For each of these elements the file is now retrieved from the server, meaning that for each image a request-response pair of the HTTP protocol is executed.

The long time taken to build an HTML page is compensated for by various measures in this case. One measure is for protocol HTTP/1.1 to allow a connection to be held open so that there is no connection setup and cleardown. Furthermore the browser has a buffer (cache), from which elements already previously loaded can be taken. However this last measure is devalued by the propensity of graphic designers to use different graphics on each page. In addition the cache can only buffer elements with identical addresses. When a link which leads to another computer is activated, all the graphics are to be reloaded from there when this page is visited for the first time. The problem merely becomes less visible to professional users because of the high processing speeds and today's fast network connections. It is becoming evident however that even private users are no longer prepared to wait for a long time for a page to be built UP and if necessary they no longer take a commercial site into account if they feel that its pages take too long to load.

For the specific class of embedded objects called JAVA applets the HTML tag makes provision for specifying not only the name of the JAVA class to be executed but also the address of a JAR archive in which the class is to be contained. The browser then loads the entire archive and takes the class as well as the objects needed by it from the archive.

Using this as a starting point, U.S. Pat. No. 6,026,437 proposes an improvement. If in the traditional solution first the HTML document and then the JAR archive have to be loaded in two separate calls, said application proposes that the hypertext link points to a JAR archive containing exactly one HTML document using the JAR archive. This solution however requires prior changes to all browsers since the optimization is undertaken by changing the syntax of the links.

### SUMMARY OF THE INVENTION

The present invention, in one-embodiment, discloses a solution with which the objects needed on a page can be transmitted with one network transfer and which is still compatible with the previous application. In particular, the HTML page is to remain unchanged; Server and browser are merely expanded so that an improved server with an improved browser produces an increase in efficiency, but the remaining three combinations remain operable without any changes.

The solution uses the ability of the browser, when the HTML page is requested, to set an indicator which is ignored by previous servers and is used by new servers, to send an archive including the HTML page rather than the HTML page itself. Unlike a JAR archive, this archive is not set in the cache as an entity but is unpacked and loaded element-by-element into the cache. The archive can include any elements addressable by a URL which are then used automatically by the cache mechanism. Also, by contrast with the stated prior art, it is thus not necessary for all of the elements included in the page to be included in the archive. In particular, it will frequently be sensible to not actually integrate a JAR archive and to load it separately. Elements can also be included that are indirectly linked, if for example a page links to another page which in its turn includes graphics and these have already been transferred along with the first page.

In summary, the invention is presented as follows: When an HTML page is requested the browser sets an indicator, on the basis of which, instead of the HTML page, the server sends back an archive which is unpacked by the browser in the cache. The archive typically includes the images needed by the page which are then retrieved from the cache, so that one network transfer per page is needed. The invention is compatible to previous operation, especially through its use of content negotiation in accordance with RFC 2295 or remote variant selection in accordance with RFC 2296.

### BRIEF DESCRIPTION OF THE DRAWINGS

The invention is explained below in greater detail on the basis of exemplary embodiments illustrated in the figures, in which:

FIG. 1 shows an arrangement on the basis of which the execution sequence is to be described.

### DETAILED DESCRIPTION OF THE INVENTION

The wavy line 10 signifies a network to which a client below the wavy line 10 and a server above the wavy line 10 are connected. The network and the connections are preferably realized with the Internet protocol HTTP.

In the client is an HTML document 12 which includes a link, here ‘<a href=“test1.html”>link</a>’. Activation of the link directs a request to HTTP process 14. The HTTP process includes a switch 16 which is used to decide whether the requested document “test1.html” is taken from mass storage 18 as previously and sent back to the client or whether the extension to be described below is to be applied. The browser in the client which has requested the page comprises a control 22 for a cache 24.

The typical structure of the requested document “test1.html” is as shown below:

<HTML><HEAD><TITLE>TEST1</TITLE></HEAD>

<BODY><H1>TEST1</H1>

Image: <IMG SRC=img1.jpg ALT=“img1”>

Link: <A HREF=test2.html>test2</a>

Script: <srcipt src=script1.js></Script>

JAVA-Applet: <APPLET src=an applet.java></applet>

</BODY></HTML>

In the case in which the server process 14 merely sends back the requested document as previously, this document is entered in the usual way by the control 22 into the cache 24 and is then available to the browser as document 26. A number of links are contained in document 26, these being the links ‘<img src=img1.jpg>’, <a href=test2.html>” and <Script src=script1.js>”. The browser now interprets the document “test1.html” and encounters these very links, whereon the specified files “img1.jpg”, “test2.html” and “script1.js” are requested in turn from the server, stored in the cache 24 and then functionally inserted into HTML text 26.

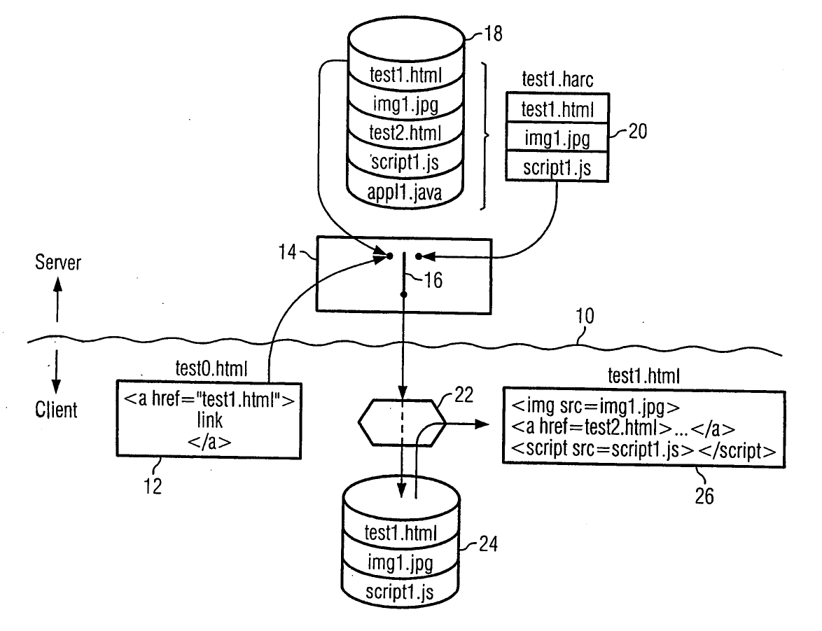

The invention modifies the execution sequence as follows: An indicator in the request of “test1.html” notifies the server process 14 that, instead of the requested file, an archive can also be processed. This indicator is explained in more detail below. If this indicator is set, the server process 14 checks whether there is a corresponding archive 20, called ‘test1.harc’ here, and then just sends back this archive 20, symbolized by the switch 16. A corresponding entry in the header in accordance with the protocol HTTP, for example the (new) MIME type ‘archive/harc’ instead of ‘text/html’, indicates to the cache process 22 that an archive is being transferred instead of a single document. The cache process 22 then breaks the archive down into its elements and stores these elements individually in the cache 24, as indicated in FIG. 1. Let the file ‘test1.html’ be included in the archive, as in the example. Since this is now in the cache it can be made available to the browser as previously. The latter interprets the HTML text and establishes that further files are also required. As ever, this initially involves checking whether these are in the cache. Since this is the case, these further files ‘img1.jpg’, ‘test2.html’ and ‘script1.js’ are taken from the cache; Communication to the server is no longer necessary.

For the indicator with which the client notifies the server that an archive is welcome a new element can be defined in the HTTP header. Preferably, however, content negotiation in accordance with RFC 2295 or remote variant selection in accordance with RFC 2296 is used. The latter is preponderantly used to request different language variants of an HTML page and thus, in order not to lose this capability, cannot be used without restriction. Content negotiation is better, this having previously been used to get the server not to send the original file but a compressed version. For this the formats known to the browser are enumerated in the header of the request; the server can then send these formats. A browser with a cache in accordance with the invention uses this header and inserts an appropriate (MIME) type. A server which is not designed to accept it ignores this format and behaves as before. A server in accordance with the invention also sends the archive format if the browser has declared that this is possible. This means that this is one option of implementing the indicator described above.

In another variant the browser is set up so that, instead of the file ‘test1.html’, it first requests the file ‘test1.harc’ and, if the server shows this to be unavailable, then requests the original ‘test1.html’. The modified file type then represents the above-mentioned indicator.

In a further embodiment of the invention, the indicator allowing an archive is set if the document is not yet in the cache. In the case in which, although it is in the cache it is no longer valid, an archive is no longer allowed since the other elements can still be entirely valid.

A further embodiment makes the request for an archive dependent on none or a specified number or older documents of the same server being in the cache.

On the server side one solution is for manually or automatically maintained lists, also implemented by means of a database, to be present which assign archives to the file names of the pages. If the file name is found in one of the lists and if the assigned archive exists, then the archive is transferred instead of the file.

The server can also look each time for existing archives and can look in these archives for the page and automatically transfer the archive if hits are registered.

In another embodiment, a check is made as to whether the subdirectory in which the requested file is stored or should be stored includes an archive. If it does, the archive is transferred instead of the file. Optionally a check can be made beforehand as to whether the file is contained in the archive. In a further development, if no archive is present, this is created, stored and transferred from files of the subdirectory ‘on the fly’. In this case a positive or negative list of file types, especially using their extensions, will preferably define for example that JAVA archives (.jar) will not be included.

With an alternative application of the invention the cache of an agent called a proxy is used. A proxy server receives the request from the browser and for its part submits it to the server, receives the requested document in return and then forwards this to the browser. One of the functions of a proxy server is to protect the system by routing outgoing requests via a single dedicated system. A proxy server such as ‘SQID’ or the corresponding Apache module is mostly combined with a cache in order to transfer the pages requested via the expensive external connection as frequently as possible from the proxy without any load being imposed on the external connection. Therefore the proxy server can set the indicator, receive an archive, unpack this archive into the cache and then efficiently supply a large number of conventional browsers via the fast and low-cost internal network with parts of external HTML pages.

As a rule and thus preferably the archive sent by the server contains the requested file which is then further processed from the cache.

To enable it to offer robust protection against errors the control for the cache should also be able to handle the case where the archive received does not include the requested file. Since no general decision can be taken, in this case as to whether the content of the archive is to be rejected on security grounds or can still be selected in the cache, this choice is set by means of user options and can depend on whether simple HTTP or secured HTTPS was used as a protocol. Furthermore the requested file can either be immediately treated as not present (error 404 in the HTTP protocol). Or there can preferably be a second request in which the indicator that an archive is welcome is not set and thus the page is again requested individually.

After an archive to which the requested file is assigned is determined, one option for the server is to check whether the requested file is present in the archive and then to send the archive, another is to still send the file itself. This solution is simple, easy to understand and robust against errors in the assignment of files and archives.

However it is better for an additional check to be made to ensure that the file is not just present in the archive but is also up-to-date. If it is up-to-date and present, the archive is sent. If it is not up-to-date, either just the page is sent or the current page is replaced temporarily or permanently in the archive by the current version and the archive is then sent.

If it is not present the archive can still be sent, assuming that the control of the cache, as described above, then requests the page again, but without an archive indicator. This case relates to HTML pages which, although the pages are changed more frequently, the images etc. used within them are changed very rarely. With this embodiment an archive which contains the objects needed by the page is always so-to-speak sent before the page.

With a development of this variation the server sends two files when a file is requested; namely an archive without the file and then or previously the file itself.

The indicator which shows that an archive can be supplied instead of the requested page is useful but not vital for the invention. Let us take the example of a closed network, as is often the case with self-service terminals. It can then be assumed that browsers are in a position to receive an archive instead of the requested file; an explicit marking is no longer necessary. The same applies to data delivered by the server: The MIME type in the header is preferably used to show that an archive is being sent. Alternatively, however, each file received can initially be interpreted as an archive and if the archive concerned is not valid be treated as a single file.

One of the formats known below as ‘arc’, ‘zip’, ‘tar’, ‘cpio’, ‘cab’, ‘lha’ etc. can be used as the archive format, in which the files are packed into a new file representing the archive. Frequently compression is also used here and the transmission thus further accelerated, provided the packed files are not already compressed as is the case with the widely-used image formats ‘gif’, ‘jpg’ and ‘png’.

Another option with the HTTP(S) protocol is to encode the data sent back as a multi-part message with separators in accordance with the MIME standard RFC-2046 (multi-part message). In this case, a number of individual files are linked by separators in an overall stream. The data type of the header is then ‘multipart/mixed’. The advantage of this variation is that dynamic assembly in the server is then especially simple. Preferably, the requested file itself is sent as the first part. Following this, either a prepared file is added which already represents a multipart message and which can then be simply added (if necessary by adapting the boundary delimiter). Or, in accordance with a database entry or a miscellaneous list, the files included there are added individually. This variation is functionally equivalent to a traditional archive and is thus viewed in the context of the invention as an archive format.

The invention has been described using HTML pages. It is equally applicable to further markup pages, such as the successor XHTML, the extension XML, as well as to other suitable formats.

1. A server for a number of files defined by addresses, where the server uses the address included in a request for a file to determine whether the file or an archive including a number of files, is returned.

2. The server in accordance with claim 1, wherein the request includes an archive indicator and an archive is returned instead of the file when the indicator is present.

3. The server in accordance with claim 2, wherein the indicator is implemented by a content selection.

4. The server in accordance with claim 1, wherein an associative list is used and,
if this assigns another file to the address of the requested file, this file is sent, and
if a number of files are assigned to the requested file, the files are sent as an archive.

5. The server in accordance with claim 1, wherein the requested file searches in existing archives and, if the requested file is present, sends back the archive instead of the file.

6. The server in accordance with claim 1, wherein the requested file is located in a directory and, instead of the file, an archive made up of files of the directory, formed in accordance with specified selection criteria, is returned.

7. The server in accordance with claim 1, wherein the archive is structured as a multi-part message with separators.

8. A cache with entries for addressed files, where the cache is an associative memory which has an index with the address of the cached files and a memory with respective contents, wherein;
if a requested file is not present in the cache or is invalid, it is requested with its address from a server determined by the address, and
if an archive into which a number of files are packed is sent from the server in place of the addressed file, the archive is unpacked and the files are stored individually in the cache, so that subsequent requests for these files can be satisfied from the cache.

9. A browser for markup pages, including a cache in with entries for addressed files where the cache is an associative memory which has an index with the address of the cached files and a memory with respective contents, wherein
if a requested file is not present in the cache or is invalid, it is requested with its address from a server determined by the address, and
if an archive into which a number of files are packed is sent from the server in place of the addressed file, the archive is unpacked and the files are stored individually in the cache, so that subsequent requests for these files can be satisfied from the cache.
